(19) United States
(12) Patent Application Publication
(10) Pub. No.: US 2026/0267569 A1
(43) Pub. Date: Sep. 10, 2026

(54) STORAGE MEDIUM STORING APPLICATION PROGRAM, CONTROL METHOD, AND INFORMATION PROCESSING APPARATUS

(71) Applicant: CANON KABUSHIKI KAISHA, Tokyo (JP)

(72) Inventor: TAKUYA SAITO, Chiba (JP)

(21) Appl. No.: 19/553,874

(22) Filed: Mar. 2, 2026

(30) Foreign Application Priority Data
Mar. 7, 2025 (JP) 2025-036274

(51) Int. Cl. G06F 3/12

(52) U.S. Cl. CPC G06F 3/1205; G06F 3/1258

(57) ABSTRACT

A non-transitory computer-readable storage medium storing an application program supporting a standard driver which is provided from a provider of an operating system. The application program causes an information processing apparatus o execute a control method including displaying a reception screen for receiving a setting of a combining instruction for combining additional data with image data generated by executing a reading function of the information processing apparatus for reading an original, and transmitting the combining instruction set on the reception screen to the image processing apparatus.

### BACKGROUND

### Field of the Technology

The present disclosure relates to a storage medium storing an application program, a control method, and an information processing apparatus.

### Description of the Related Art

To a scanning device (scanner) that performs image reading, i.e. scanning, a host computer (information processing apparatus) that is capable of processing information between the same and the scanning device is communicably connected. As control software for controlling the scanning device, for example, a scan driver installed from the scanning device into the host computer is used. With this scan driver, it is possible to provide a scan instruction from the host computer to the scanning device. In the host computer, an operating system (hereinafter referred to as the “OS”) as basic software is installed in advance. The scan driver is configured according to specifications defined by the OS and can operate when called from the OS. Further, the scan driver is different for each vendor that supplies a scanning device, i.e. is a model specific scan driver which is suitable on a scanning device basis.

In recent years, in Windows (registered trademark), a standard class driver (hereinafter sometimes referred to as the “standard driver”) is provided, which can be commonly used even for scanning devices supplied from a plurality of different vendors, respectively. The standard driver is incorporated in the OS in advance. Then, by connecting a desired scanning device to a host computer having the OS incorporating the standard driver, the standard driver can be used. This makes it possible to omit installation of a model-specific scan driver. Further, the standard driver is assumed to be configured to enable designation of a scan function of the scanning device according to scan function information generated based on information acquired from the scanning device. This makes it possible to designate a scan function for each scanning device by one standard driver.

The standard driver can be commonly used for the scanning devices of a plurality of different vendors, and hence, for example, there is a case where it is impossible to cause a scanning device of a predetermined vendor to execute part of functions of this scanning device. Japanese Laid-Open Patent Publication (Kokai) No. 2019-74906 discloses an application that extends a function which can be designated when printing is performed in a case where a printer driver supplied from a vendor of a printing apparatus has only basic functions, such as functions of a standard printer driver.

As mentioned above, the scan driver is a model specific scan driver that is different for each vendor which supplies a scanning device, i.e. suitable on a scanning device basis. As this scan driver, there is a driver that gives a combining instruction to a scanning device, for combining data, such as a date and a page number, with image data generated by execution of scanning. However, it is impossible to give a combining instruction by the standard driver.

### SUMMARY

The present disclosure is directed to providing a mechanism that makes it possible to give a combining instruction for combining additional data with image data generated by executing a reading function even in a case where a standard driver is used.

In a first aspect of the present disclosure, there is provided a non-transitory computer-readable storage medium storing an application program supporting a standard driver which is provided from a provider of an operating system, the application program causing an information processing apparatus to execute a control method including displaying a reception screen for receiving a setting of a combining instruction for combining additional data with image data generated by executing a reading function of an image processing apparatus for reading an original, and transmitting the combining instruction set on the reception screen to the image processing apparatus.

In a second aspect of the present disclosure, there is provided a control method of performing control to support a standard driver which is provided from a provider of an operating system, including displaying a reception screen for receiving a setting of a combining instruction for combining additional data with image data generated by executing a reading function of an image processing apparatus for reading an original, and transmitting the combining instruction set on the reception screen to the image processing apparatus.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a hardware configuration of a scan system.

FIGS. 2A and 2B are block diagrams each showing a software configuration of the scan system according to a first embodiment.

FIGS. 3A to 3D are diagrams each showing an example of a screen displayed on a display section of the scan system.

FIG. 4 is a flowchart of a process performed by a scan function-extending unit, for editing scan function information.

FIGS. 5A to 5C are diagrams each showing an example of a list of the scan information.

FIG. 6 is a sequence diagram showing a process executed between a scan application, general-purpose scan software, an extension application, and a scanning device, after the scan application receives a scan setting.

FIG. 7 is a flowchart of a process performed by the extension application.

FIG. 8 is a diagram showing an example of a screen displayed on the display section of the scan system according to a second embodiment.

FIG. 9 is a flowchart of a process performed by the scan function-extending unit, for editing the scan function information.

FIG. 10 is a sequence diagram showing a process executed, in the second embodiment, between the scan application, the general-purpose scan software, the extension application, and the scanning device, after the scan application receives a scan setting.

FIG. 11 is a flowchart of a process performed by the extension application.

FIG. 12 is a sequence diagram showing a process executed, in a third embodiment, between the scan application, the general-purpose scan software, the extension application, and the scanning device, after the scan application receives a scan setting.

FIG. 13 is a sequence diagram showing a variation of the process executed, in the third embodiment, between the scan application, the general-purpose scan software, the extension application, and the scanning device, after the scan application receives a scan setting.

FIG. 14 is a sequence diagram showing a process executed, in a fourth embodiment, between the scan application, the general-purpose scan software, the extension application, and the scanning device, after the scan application receives a scan setting.

FIG. 15 is a flowchart of a process performed by the extension application.

### DESCRIPTION OF THE EMBODIMENTS

The present disclosure will now be described in detail below with reference to the accompanying drawings showing embodiments thereof. The configuration described in the following embodiments is given only by way of example, and is by no means intended to limit the scope of the present disclosure. For example, components of the configuration of the present disclosure can be replaced with desired components which can exhibit the same functions. Further, desired components can be added. Further, two or more desired components (features) of the embodiments can be combined.

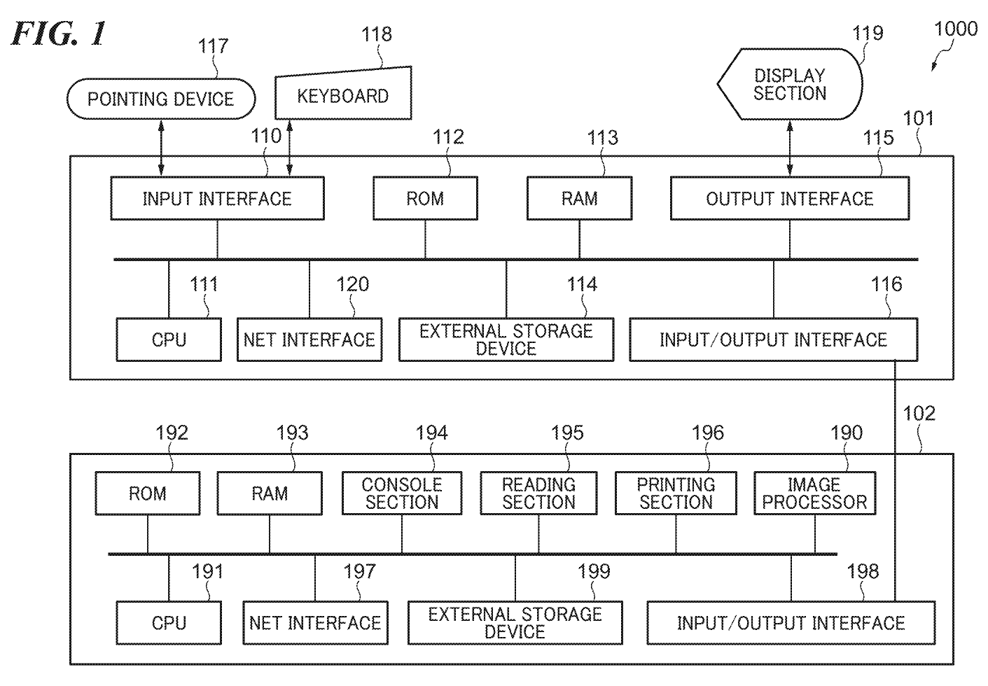

A first embodiment will be described below with reference to FIGS. 1 to 7.

FIG. 1 is a block diagram showing a hardware configuration of a scan system according to the first embodiment. As shown in FIG. 1, the scan system, denoted by reference numeral 1000, includes a host computer 101, a scanning device (scanner) 102, a pointing device 117, a keyboard 118, and a display section 119, and these are communicably connected to each other. The host computer 101 is an information processing apparatus and includes an input interface 110, a central processing unit (CPU) 111, a read only memory (ROM) 112, a random access memory (RAM) 113, an external storage device (storage medium) 114, an output interface 115, an input/output interface 116, and a NET interface 120. Note that although as the host computer 101, for example, a desktop-type personal computer can be used, this is not limitative, but for example, a laptop-type personal computer, a tablet terminal, and a smartphone can be used.

The CPU 111 is a computer that executes e.g. programs stored in the ROM 112 and the external storage device 114. Note that in the present embodiment, the CPU 111 is capable of executing functions and processing of the host computer 101, i.e. steps (control method), described hereinafter, by performing processing according to a program code stored in the ROM 112. In the ROM 112, an initialization program is stored. In the external storage device 114, an application program group, an operating system (OS), print data generation software, and a variety of other data are stored. Note that in the present embodiment, as the OS, Windows (registered trademark) 11 of Microsoft (registered trademark) has been installed in the host computer 101. The external storage device 114 is not particularly limited, but for example, a hard disk drive (HDD) or a solid state drive (SSD) can be used. The RAM 113 is used e.g. as a work memory when a variety of programs stored in the external storage device 114 are executed, and the variety of programs can operate in the host computer 101. To the input interface 110, the pointing device 117 and the keyboard 118 as input devices are connected. To the output interface b, the display section 119 as a display device is connected. On the display section 119, for example, a scan setting screen 300A and a detailed settings screen (reception screen) 300C, described hereinafter, are displayed. The NET interface 120 is a network interface and performs control to transfer data to and from an external apparatus via a network. To the input/output interface 116, the scanning device 102 is connected. This enables the host computer 101 to communicate with the scanning devices 102 of a plurality of makers, i.e. process information between the host computer 101 and the scanning devices 102 of the plurality of makers regardless of the makers of the scanning devices 102. The host computer 101 and the scanning device 102 can be wired connected or can be wirelessly connected.

The scanning device 102 includes an image processor 190, a CPU 191, a ROM 192, a RAM 193, a console section 194, a reading section 195, a printing section 196, a NET interface 197, an input/output interface 198, and an external storage device 199. The CPU 191 is a computer that executes e.g. programs stored in the ROM 192 and the external storage device 199 and performs centralized control of the scanning device 102. The ROM 192 is a memory for storing the programs. The RAM 193 is a memory for temporarily storing a program and image data. On the console section 194, a variety of operation instructions can be provided to the scanning device 102. Note that the console section 194 is configured to be capable of displaying a variety of information, such as a state of the scanning device 102. The reading section 195 scans (reads) an image from an original. The printing section 196 prints an image on a sheet based on image data generated e.g. by reading an image from an original in the reading section 195. Note that the printing section 196 can be omitted. The NET interface 197 is a network interface and performs control to transfer data to and from an external apparatus via a network. To the input/output interface 198, the host computer 101 is connected. To the image processor 190, for example, image data generated by reading an image from an original in the reading section 195 is input. Then, the image processor 190 performs various types of edit processing operations on the image data.

The scanning device 102 is not particularly limited insofar as it is an apparatus having an image reading function, i.e. a scan function, and, for example, an image processing apparatus, such as a multi-function peripheral (MFP), can be used. Further, the scanning device 102 has an original platen glass (not shown) and a feeder (not shown). The original platen glass is a first placement section on which one original as an execution target of the reading function is placed. The feeder is a second placement section which is arranged at a location different from the original platen glass and on which a plurality of original sheets each as an execution target of the reading function are placed. Further, in a case where the MFP is used as the scanning device 102, printing performed by the MFP is printing using the electrophotographic method in the present embodiment but is not limited to this, and, for example, printing using the inkjet method can be performed. Further, although in the present embodiment, the host computer 101 and the scanning device 102 are configured as separate apparatuses different from each other, this is not limitative. For example, the host computer 101 and the scanning device 102 can be formed as an integrated apparatus.

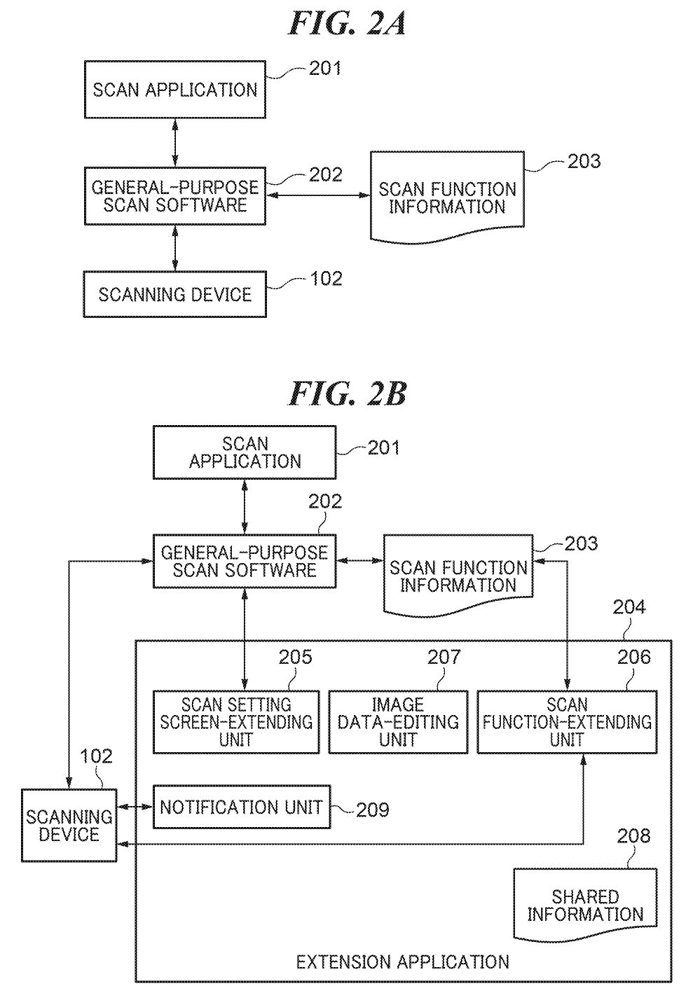

FIGS. 2A and 2B are block diagrams each showing a software configuration of the scan system. FIG. 2A is a diagram showing a general configuration in a case where an extension application (application program) 204 is not associated with general-purpose scan software (standard driver) 202 and the scanning device 102. FIG. 2B is a diagram showing a configuration in a case where the extension application 204 is associated with the general-purpose scan software 202 and the scanning device 102. The general-purpose scan software 202 is a standard driver that is provided from a provider of the OS and incorporated in the OS in advance. The standard driver is a class driver (general-purpose program) which can be commonly used for the scanning devices 102 of a plurality of makers, for example, when scanning (image reading) is performed. The standard driver is provided as one of functions in the OS package with the OS. The standard driver can perform processing for a variety of scanning devices by using a standardized scanning method. With this, the standard driver can generate and output an instruction which can be interpreted by the scanning devices 102 of the plurality of makers. Note that the standard driver is not particularly limited, but for example, a program which operates based on the Internet Printing Protocol (IPP) is used. This general-purpose scan software 202 is installed (incorporated) in the OS in advance.

The extension application 204 is a program which supports, i.e. assists the general-purpose scan software 202 (program that executes a control method of performing control to support the general-purpose scan software 202). In the present embodiment, the extension application 204 is an extension program which can extend functions which cannot be executed by the general-purpose scan software 202 for the scanning device 102, but is not limited to this. For example, the extension application 204 can be a program which improves the convenience of functions which can be executed by the general-purpose scan software 202 for the scanning device 102. The extension application 204 is stored e.g. in the external storage device btogether with the OS (the general-purpose scan software 202). With this, the host computer 101 has the general-purpose scan software 202 and the extension application 204.

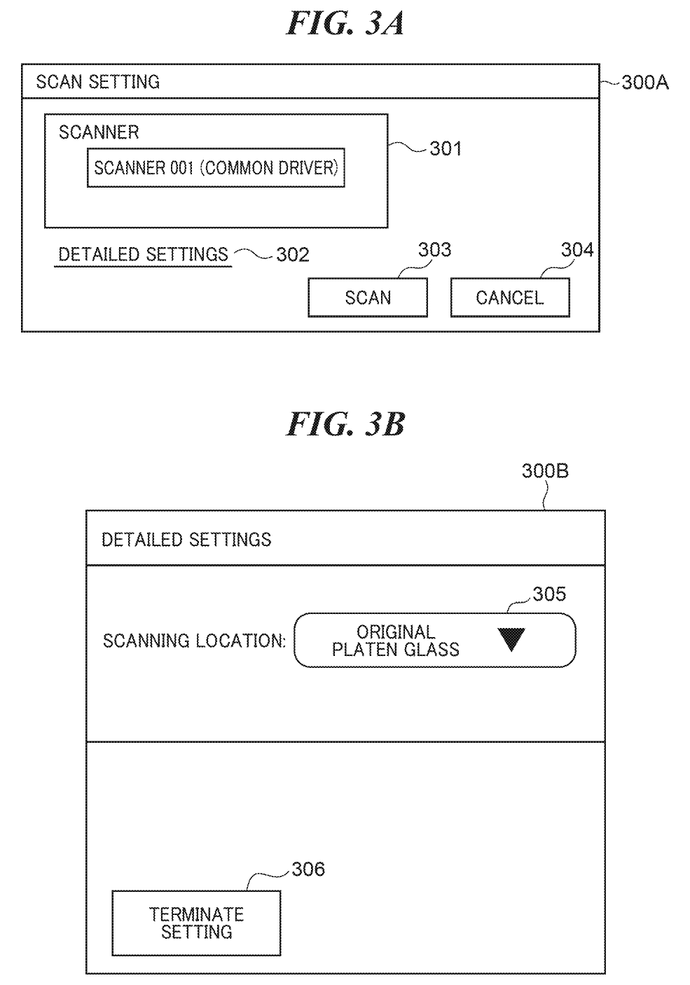

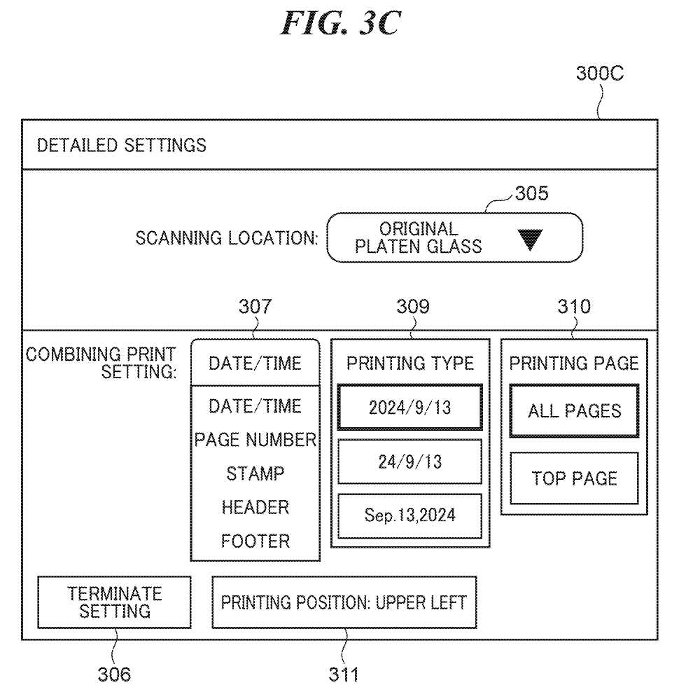

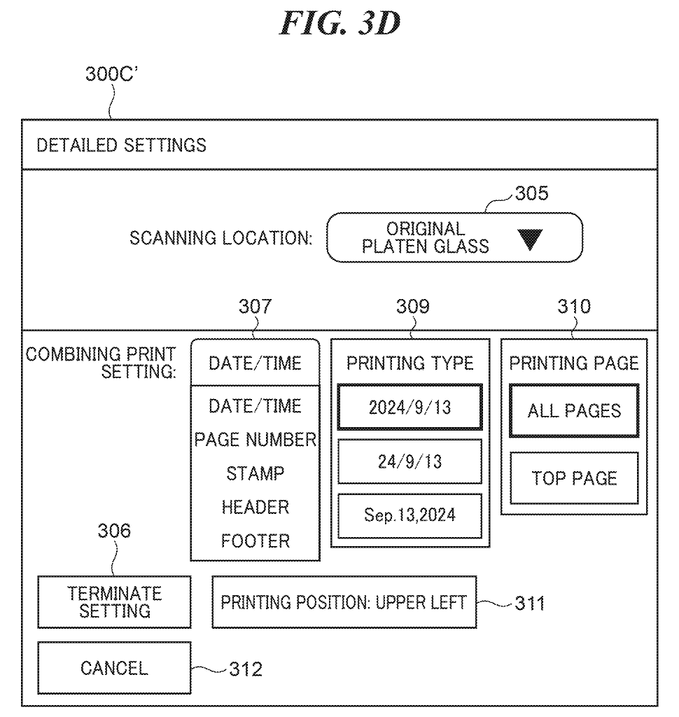

First, with reference to FIG. 2A, the configuration in the case where the extension application 204 is not associated with general-purpose scan software 202 and the scanning device 102 will be described. A scan application 201 is software for taking in contents (image data) generated by scanning performed by the scanning device 102. The scan application 201 is not particularly limited, and, for example, a document generation application and an image editing application are used. The scan application 201 issues a scan instruction to the OS e.g. upon receipt of a scan request from a user. The scan instruction includes scan setting information for instructing operations of the general-purpose scan software 202 and the scanning device 102. To issue a scan instruction, the scan application 201 can display the scan setting screen 300A, provided by one of the general-purpose scan software 202, the OS, and the scan application 201, on the display section 119. Further, by operating a control 302 (see FIG. 3A) in the scan setting screen 300A, the scan application 201 can display, for example, a detailed settings screen 300B (see FIG. 3B) on the display section 119. The scan setting screen 300A and the detailed settings screen 300B, and further, the detailed settings screen 300C will be described hereinafter. The scan setting screen 300A includes a setting item indicating a scan function which can be set according to capabilities information acquired by the general-purpose scan software 202, i.e. information based on which the scan setting can be performed, and a control item indicating a setting of the scan function. The capabilities information refers to information related to the capabilities of the scanning device 102 for performing scan and the like. Further, with this capabilities information, for example, it is also possible to determine whether or not information which enables the display of the detailed settings screen 300C is included. Then, as a result of this determination, if it is determined that the information which enables the display of the detailed settings screen 300C is included, the detailed settings screen 300C can be displayed. On the other hand, if it is determined that the information which enables the display of the detailed settings screen 300C is not included, the display of the detailed settings screen 300C is inhibited, but the detailed settings screen 300B is displayed. Thus, the extension application 204 can switch whether or not to display the detailed settings screen 300C according to the capabilities information of the scanning device 102.

Referring again to FIG. 2A, scan function information 203 is data describing all scan functions which can be set, settings of these scan functions, and an exclusive relation between settings, and the like. The scan function information 203 is included in a configuration file of the general-purpose scan software 202 and is disposed in the external storage device 114 as an unchangeable file. Alternatively, the scan function information 203 is dynamically generated by the general-purpose scan software 202. Specifically, the general-purpose scan software 202 acquires attribute data of the scanning device 102 from the scanning device 102. The general-purpose scan software 202 generates the scan function information 203 according to attribute information in the attribute data. Note that in a case where the scan function information 203 is dynamically generated as described above, the scan function information 203 can be edited. Further, the attribute data of the scanning device 102 includes the attribute information indicating the functions which can be designated in the scanning device 102 (capabilities of the scanning device 102) and settings associated with the attribute information, and these are stored in the RAM 113.

With this configuration, the general-purpose scan software 202 enables a user to designate a scan function which can be used in the scanning device 102 according to the scanning device 102 connected to the host computer 101. With this, regardless of the scanning device 102, i.e. even in a case where the scanning device 102 having a different function or the scanning device 102 developed by a different scanner maker is connected, it is possible to designate a scan function which can be used in the connected scanning device 102. Note that in the present embodiment, the general-purpose scan software 202 is a standard class driver that executes scanning based on a standard scan protocol called Mopria (registered trademark). Specifically, as described above, the general-purpose scan software 202 is not a scan driver specific to a model of the scanning device 102 but is a standard class driver which can be commonly used for scanning devices 102 of scanner makers, without depending on a specific scanner maker. Further, the general-purpose scan software 202 acquires the capabilities information of the scanning device 102 and generates the scan function information 203 based on the acquired information.

Further, the general-purpose scan software 202 can be associated with the extension application 204. This enables the general-purpose scan software 202 to execute a function which is not supported by the general-purpose scan software 202. For example, the general-purpose scan software 202 cannot cause the scanning device 102 to set a combining instruction for combining additional data, which is to be added to image data generated by executing the scan function of the scanning device 102 and be printed with this image data, with the image data. Thus, the general-purpose scan software 202 does not support the combining instruction setting (combining print function). This is because this combining instruction setting is a function uniquely executed by the scanning device 102 manufactured by a predetermined scanner maker. The extension application 204 can extend functions of the general-purpose scan software 202 such that functions which cannot be executed by the general-purpose scan software 202 can be executed. Although in the present embodiment, the general-purpose scan software 202 cannot perform the combining instruction setting and the extension application 204 can extend the function such that the combining instruction setting can be executed, this is not limitative. For example, the general-purpose scan software 202 can execute part of the combining instruction setting, and the extension application 204 can further extend the execution range by compensating for the shortage of the combining instruction setting.

With reference to FIG. 2B, the configuration in the case where the extension application 204 is associated with the general-purpose scan software 202 and the scanning device 102 will be described. As shown in FIG. 2B, differently from FIG. 2A, in this configuration, the extension application 204 is added. That is, the host computer 101 includes the scan application 201, the general-purpose scan software 202, and the scan function information 203, and further has the extension application 204. The extension application 204 is software for extending the functions of the general-purpose scan software 202 and is sometimes simply referred to as the scan software. Note that the extension application 204 is software which is not included (packaged) in the OS in advance. Therefore, the extension application 204 is downloaded from a server (not shown) via the Internet and installed into the host computer 101 according to a user’s operation of the host computer 101. Alternatively, when the scanning device 102 is connected to the host computer 101, the extension application 204 can be automatically installed into the host computer 101 according to this connection. Specifically, in a case where the scanning device 102 is connected to the host computer 101, the OS acquires device identification information from the scanning device 102. The OS can download the extension application 204 associated with this device identification information from the server via the Internet and install the downloaded extension application 204. As a result, in the host computer 101, the general-purpose scan software 202 and the extension application 204 are held as control programs different from each other. Note that the general-purpose scan software 202 and the extension application 204 are sometimes updated and their versions are upgraded, respectively. The processing for updating the general-purpose scan software 202 and the processing for updating the extension application 204 in this case are performed at the same timing or at different timings. Further, a trigger with which the general-purpose scan software 202 is acquired by the host computer 101 and a trigger with which the extension application 204 is acquired by the host computer 101 can be the same trigger or the different triggers. Further, in a case where the extension application 204 has been installed, the OS associates the extension application 204 with the general-purpose scan software 202 and the scanning device 102.

As shown in FIG. 2B, the extension application 204 is capable of exchanging information (transmission and reception of information) with the general-purpose scan software 202 and the scanning device 102, respectively. That is, the extension application 204 is associated with the general-purpose scan software 202 and the scanning device 102. In the present embodiment, the extension application 204 includes a scan setting screen-extending unit 205, a scan function-extending unit 206, an image data-editing unit 207, and a notification unit 209. Further, the extension application 204 includes shared information 208 which can be accessed from each of the scan setting screen-extending unit 205, the scan function-extending unit 206, the image data-editing unit 207, and the notification unit 209. The shared information 208 is a file stored in the external storage device 114 or information stored in the RAM 113. The extension application 204 can write in and read from the shared information 208 by using an Application Program Interface (API) provided by the OS.

Note that the extension application 204 can terminate the entire operation of the extension application 204 in accordance with termination of processing executed by any of the scan setting screen-extending unit 205 to the notification unit 209. In this case, the OS starts the extension application 204 whenever a request for causing any of the units to execute processing is received. Further, while the processing is being performed by any of the scan setting screen-extending unit 205 to the notification unit 209, the extension application 204 can cancel this processing. In this case, a job being processed on a print queue is deleted by the OS. As described above, upon receipt of a print request from a user, the scan application 201 issues a scan instruction to the OS. Further, the scan application 201 can display the scan setting screen. In the configuration shown in FIG. 2B, the scan application 201 can display the detailed settings screen 300C provided by the scan setting screen-extending unit 205 (the extension application 204). Further, the scan setting screen-extending unit 205 can store detailed settings made by the user in the shared information 208.

The image data-editing unit 207 acquires image data from the scanning device 102. Then, after acquisition of the image data, the image data-editing unit 207 can also edit the acquired image data. Further, the image data-editing unit 207 acquires detailed setting information from the shared information 208 and performs image editing on the image data according to the detailed setting information. The extension application 204 can perform image editing on image data acquired by the general-purpose scan software 202 according to the detailed setting information. Further, even in the configuration shown in FIG. 2B, there is a case where the combining instruction setting is not executed. In this case, the general-purpose scan software 202 can transmit a scan request instruction to the scanning device 102 without via the extension application 204.

The scan function-extending unit 206 can edit the scan function information 203 generated by the general-purpose scan software 202 or the OS. This makes it possible to add a function provided by the extension application 204. Further, it is also possible to add a function (e.g. the combining instruction-setting function) which can be executed in the scanning device 102 but cannot be executed by the general-purpose scan software 202 and add an exclusive relationship between settings of the scan function and the like. The OS starts the scan function-extending unit 206 when the extension application 204 is associated with the scanning device 102 and the general-purpose scan software 202 for the first time. Further, the OS can start the scan function-extending unit 206 at a timing other than this (such as a timing when the OS is started). By starting the scan function-extending unit 206 as described above, the scan function-extending unit 206 can detect the extended function and add the detected function to the scan function information 203, even in a case where a function related to scanning is extended later.

The notification unit 209 can provide, when an error of the scanning device 102 occurs, a notification indicating this fact. For example, if a reading jam error has occurred in the scanning device 102, the general-purpose scan software 202 detects occurrence of this error. The OS displays a message showing occurrence of the reading jam error as a result of the detection performed by the general-purpose scan software 202, on the display section 119, by using a notification function referred to as the toast notification which is one of the functions of the OS. Note that when the user operates the toast notification, the notification unit 209 is called by the OS, and a user interface screen (UI screen) of the notification unit 209 is displayed. On the user interface screen, for example, a detailed message concerning the reading jam error, a jam resolving method, and so forth can be displayed.

As described above, in the present embodiment, it can be said that the extension application 204 has the following four functions: The first function is the function of displaying a setting screen. This function is executed by the scan setting screen-extending unit 205. The second function is the function of editing image data according to the detailed setting information. This function is executed by the image data-editing unit 207. The third function is the function of extending a function which can be designated by using image data generation software. This function is executed by the scan function-extending unit 206. The fourth function is the function of displaying a screen in response to occurrence of an error in the scanning device 102. This function is executed by the notification unit 209. Note that the configuration of the extension application 204 is not limited to the configuration having these four functions but is preferable to have at least one function of them, and further, the extension application 204 can be configured to further have another function.

FIGS. 3A to 3D are diagrams each showing an example of a screen displayed on the display section of the scan system. FIG. 3A shows the scan setting screen displayed by the scan application 201. FIG. 3B shows the detailed settings screen displayed in the case of the configuration in which the extension application 204 is not associated. FIG. 3C shows the detailed settings screen displayed in the case of the configuration in which the extension application 204 is associated. FIG. 3D shows a variation of the detailed settings screen displayed in the case of the configuration in which the extension application 204 is associated. Note that a unit or module that displays each screen is not particularly limited. For example, the scan setting screen-extending unit 205 is only required to be configured to be capable of generating a display screen. In this case, the scan setting screen-extending unit 205 transmits the generated display screen to the scan application 201 via the general-purpose scan software 202. The scan application 201 can be configured to display the acquired display screen.

The scan setting screen 300A shown in FIG. 3A is a screen on which settings on scanning by the scanning device 102 can be made. This scan setting screen 300A includes a control (button) 301, the control 302, a control 303, and a control 304. With the control 301, the user can select and set a scanner device used for reading an original. In the illustrated example in FIG. 3A, the scanner device used for reading an original is set to “scanner 001 (common driver)” by way of example. With the control 302, the user can cause a screen to be displayed on which detailed settings on scanning can be made. With the control 303, the user can instruct execution of the scan function of the scanning device 102. With the control 304, the user can instruct cancelation of execution of the scan function of the scanning device 102.

By operating the control 302 in a case where the extension application 204 is not associated, the detailed settings screen 300B shown in FIG. 3B is displayed. The detailed settings screen 300B includes a control 305 and a control 306. The control 305 is a placement selection section on which the user can select and set an original scanning location, i.e., a placement section where an original to be read by the scanning device 102 is placed. As described above, the scanning device 102 has the original platen glass and the feeder, as the original scanning locations. In this case, on the control 305 in FIG. 3B, “original platen glass” is selected by way of example. With the control 306, the user can terminate the setting operation performed on the control 305. Further, upon operation of the control 306, the screen returns to the scan setting screen 300A shown in FIG. 3A.

By operating the control 302 in a case where the extension application 204 is associated, the detailed settings screen 300C shown in FIG. 3C is displayed (display control step). The detailed settings screen 300C is a screen on which the combining instruction setting can be received. Further, the detailed settings screen 300C is a screen displayed together with the scan setting screen 300A, but its display form is not particularly limited. For example, the detailed settings screen 300C can be displayed in a state overlapping the scan setting screen 300A. Further, the detailed settings screen 300C can be displayed adjacent to the scan setting screen 300A or can be displayed after the scan setting screen 300A once disappears. Similar to the detailed settings screen 300B, the detailed settings screen 300C includes the control 305 and the control 306.

Further, the detailed settings screen 300C includes a control 307, a control 309, a control 310, and a control 311. On the control 307, a combining print item to be combined with image data i.e. additional data is listed and displayed. As the combining print items, the above-mentioned “date/time”, “page number”, “stamp”, “header”, and “footer” are included. The user can select at least one of these as desired. In a state shown in FIG. 3C, “date/time” is selected. With the control 309, for example, in a case where “date/time” is selected on the control 307, the user can change, i.e. switch the display form (display format) used when the date is visualized, i.e. the arrangement order of the year, the month, and the day, as desired. In the state shown in FIG. 3C, the display form of the date is changed to YYYY/MM/DD selected out of the forms of YYYY/MM/DD, YY/MM/DD, and MM DD YYYY. Note that YYYY indicates a year (A.D. year), MM indicates a month, and DD indicates a date. Thus, the control 309 functions as a changing section for changing the display form used when the date is visualized.

With the control 310, for example, in a case where “page number” is selected on the control 307, the user can select a target page to which the page number is to be added, when the page number is visualized. In the state shown in FIG. 3C, “all pages” is selected as the target page out of “all pages” and “top page”. Thus, the control 310 functions as a page selection section for selecting a target page to which the page number is to be added. With the control 311, the user can select a position where this combining print item is disposed, when a combining print item (additional data) is visualized. The state shown in FIG. 3C is a state in which “upper left” is selected as the position where the combining print item is disposed. Thus, the control 311 functions as a position selection section for selecting a position where the combining print item is disposed. As described above, on the detailed settings screen 300C, settings made on the control 307, the control 309, the control 310, and the control 311 as the combining instruction-setting section can be combined as required. Then, by operating the control 306 in a state in which the settings on the respective controls have been made, the screen returns to the scan setting screen 300A. After that, by pressing the control 303 on the scan setting screen 300A, the user can give the combining instruction set on the detailed settings screen 300C to the scanning device 102 (instruction step). Note that the detailed settings screen 300C can be configured to enable cancellation of the settings on the controls. In this case, for example, a detailed settings screen 300C’ shown in FIG. 3D is displayed. The detailed settings screen 300C’ includes a control 312. For example, by operating the control 312 in a state in which the settings on the controls have been made, the user can collectively cancel these settings on the controls, and the screen returns to the scan setting screen 300A.

Here, a reason why the items included in the detailed settings screen 300B shown in FIG. 3B and the items included in the detailed settings screen 300C shown in FIG. 3C are different will be described. That is, a reason why it is possible to switch whether to display the detailed settings screen 300B or the detailed settings screen 300C will be described. The detailed settings screen 300B and the detailed settings screen 300C are generated based on respective pieces of the scan function information (capabilities information). As described above, the general-purpose scan software 202 does not support the combining instruction setting. Therefore, the combining instruction-setting function cannot be added to the scan function information only by the general-purpose scan software 202. Further, even if the combining instruction-setting function is originally included in the scan function information, the general-purpose scan software 202 cannot interpret the combining instruction-setting function included in the scan function information. For this reason, the combining instruction setting cannot be displayed on the detailed settings screen. To cope with this, the scan function-extending unit 206 adds the combining instruction-setting function to the scan function information 203. Then, the scan setting screen-extending unit 205 displays the detailed settings screen 300C by referring to the capabilities information. This detailed settings screen 300C is a screen on which the combining instruction setting can be made. Note that the detailed settings screen 300C can additionally include a setting item other than the combining instruction setting.

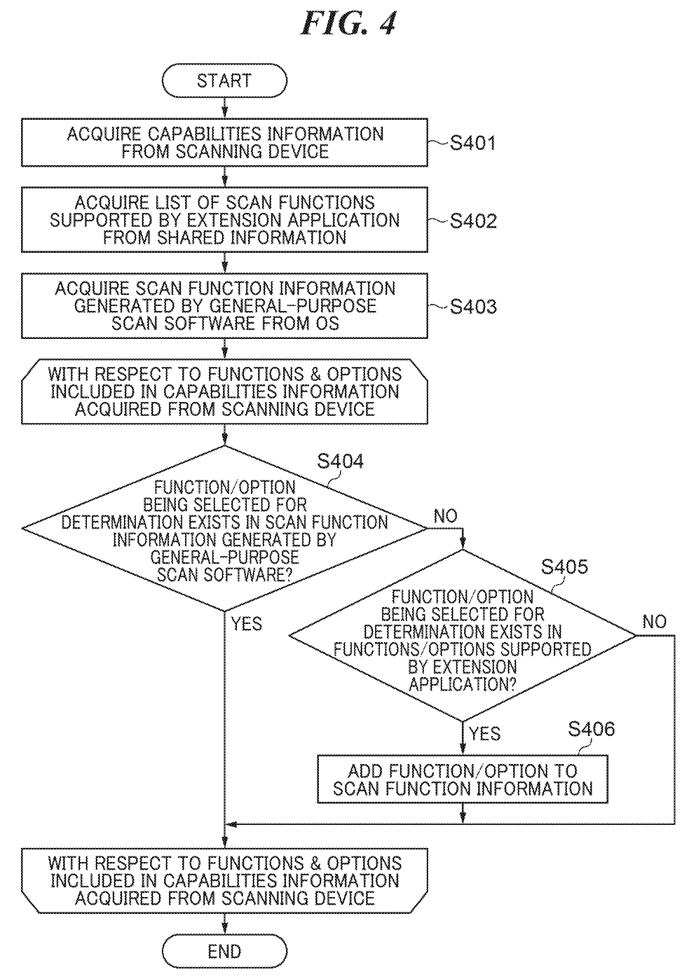

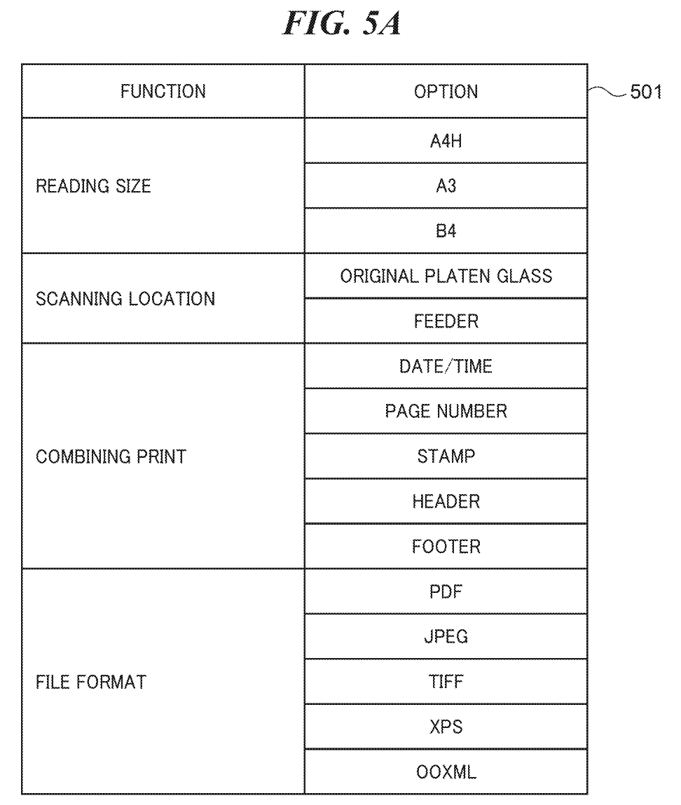

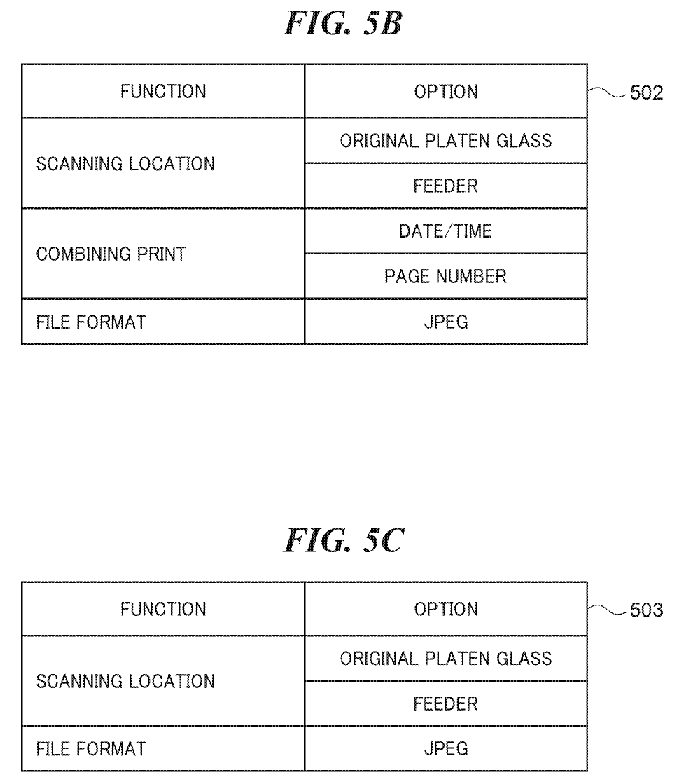

FIG. 4 is a flowchart of a process performed by the scan function-extending unit, for editing the scan function information. Note that a program for executing the process in FIG. 4 is executed by the scan function-extending unit 206 under the control of the CPU 111. FIGS. 5A to 5C are diagrams each showing an example of a list of the scan information. As shown in FIG. 4, in a step S401, the scan function-extending unit 206 acquires the capabilities information from the scanning device 102. The capabilities information is information concerning the capabilities to execute the scan function, and in the present embodiment, includes attribute information indicating the functions which can be designated in the scanning device 102 and settings associated with this attribute information. A table 501 shown in FIG. 5A indicates a list of the capabilities information acquired from the scanning device 102. As shown in the table 501, the functions of a reading size, a scanning location, combining print, and a file format, and options which can be set to each function, can be acquired from the scanning device 102. The reading size is a size of an original which can be read when the scan function is executed by the scanning device 102. The options of the reading size include, for example, A4H, A3, and B4, but are not limited to these. The scanning location is a placement section where an original is placed when the scan function is executed by the scanning device 102. The scanning location has, as its options, for example, the original platen glass and the feeder.

A combining print item and a file format can be set according to a combining instruction. The combining print item is additional data to be combined with (added to) image data. The additional data, i.e. the options of the combining print item include, for example, date/time, page number, stamp, header, and footer. The date/time is date and time at which the scan function is executed or date and time at which image data is transmitted from the scanning device 102. The stamp is a stamp (such as a background pattern) added to each page when image data is visualized. The page number is a number to be added to each page when image data is visualized. The header is an area of the top or upper part of each page in which desired information can be added, when image data is visualized. The footer is an area of the bottom or lower part of each page in which desired information can be added, when image data is visualized. Note that the additional data is not limited to the date/time, the page number, the stamp, the header, and the footer, but preferably includes at least one of these. The file format is a file format to which the format of a file is converted. The options of the file format include, for example, PDF, JPEG, TIFF, XPS, and OOXML, but are not limited to these.

In a step S402, the scan function-extending unit 206 acquires a list of scan functions supported by the extension application 204 from the shared information 208. A table 502 shown in FIG. 5B includes all scan functions which can be executed (supported) by the extension application 204 and the settings of these scan functions. As shown in the table 502, the functions of the scanning location, the combining print item, and the file format, and options which can be set for each function, can be acquired from the shared information 208. The scanning location has, as its options, for example, the original platen glass and the feeder. The combining print item has, as its options, the date/time and the page number. The options of the file format include for example, JPEG. Note that the scan functions which can be executed by the extension application 204 are sometimes updated e.g. by the update of the extension application 204.

In a step S403, the scan function-extending unit 206 acquires the scan function information 203 generated by the general-purpose scan software 202 from the OS. The scan function information 203 is generated by the general-purpose scan software 202 based on the capabilities information acquired from the scanning device 102. The scan function information 203 generated by the general-purpose scan software 202 includes only the scan functions which can be executed by the general-purpose scan software 202, out of the capabilities information acquired from the scanning device 102. A table 503 shown in FIG. 5C includes all scan functions which can be executed by the general-purpose scan software 202 and the settings of these scan functions. As shown in the table 503, the scan functions which can be executed by the general-purpose scan software 202 include the scanning location and the file format but do not include the combining print. Therefore, the combining instruction setting is not included in the scan function information 203. By adding a function and options thereof to the scan function information 203 by using the scan function-extending unit 206, the extension application 204 can compensate for lack of the function of the general-purpose scan software 202. Further, the scan function-extending unit 206 is also capable of deleting an unnecessary function and options thereof from the scan function information 203 generated by the general-purpose scan software 202.

A step S404, a step S405, and a step S406 are processing operations which are repeatedly executed on the list of the functions included in the capabilities information acquired from the scanning device 102 in the step S401. In the present embodiment, the steps S404, S405, and S406 are repeatedly executed on all of the 15 options included in the table 501.

In the step S404, the scan function-extending unit 206 determines whether or not a function and its option, being currently selected for determination, exist in the scan function information 203 generated by the general-purpose scan software 202. If it is determined in the step S404 that the function and its option, being currently selected for determination, exist in the scan function information 203, the present process is terminated if the option being selected for determination is the final item of the options of the function. Alternatively, if the option being selected for determination is not the final item of the options of the function, the next item of the options is selected, and the step S404 is executed again. On the other hand, if it is determined in the step S404 that the function and its option, being currently selected for determination, do not exist in the scan function information 203, the process proceeds to the step S405. For example, in the present embodiment, the scanning location “original platen glass” is included in the table 501, and the scanning location “original platen glass” is also included in the table 503. In this case, it is determined in the step S404 that the function and its option, being currently selected for determination, exist in the scan function information 203. On the other hand, the file format “PDF” is included in the table 501 but the file format “PDF” is not included in the table 503. In this case, it is determined in the step S404 that the function and its option, being currently selected for determination, do not exist in the scan function information 203.

In the step S405, the scan function-extending unit 206 determines whether or not the function (option), being currently selected for determination, exists in the functions (options) supported by the extension application 204. If it is determined in the step S405 that the function and its option, being currently selected for determination exist, the process proceeds to the step S406. On the other hand, if it is determined in the step S405 that the function and its option being currently selected for determination do not exist, similar to the case where the answer to the question of the step S404 is affirmative (YES), the present process is terminated if the option being selected for determination is the final item of the options of the function. Alternatively, if the option being selected for determination is not the final item of the options of the function, the next item of the options is selected, and the step S404 is executed again. For example, in the present embodiment, in a case where the function being currently selected for determination is “date/time” of the combining print, the option “date/time” of the combining print also exists in the table 502. Therefore, it is determined in the step S405 that the function being currently selected for determination exists.

In the step S406, the scan function-extending unit 206 adds the function (option) being currently selected for determination to the scan function information 203. After execution of the step S406, similar to the case where the answer to the question of the step S404 is affirmative (YES), the present process is terminated if the option being selected for determination is the final item of the options of the function. Alternatively, if the option being selected for determination is not the final item of the options of the function, the next item of the options is selected, and the step S404 is executed again.

As described above, the extension application 204 can add, to the scan function information 203, a function and its option which are not supported by the general-purpose scan software 202 but are supported by the scanning device 102, and at the same time can be supported by the extension application 204. Then, the capabilities information is generated based on the scan function information 203 edited by this addition processing. Further, by generating a display screen based on the resulting capabilities information, the scan setting screen-extending unit 205 can extend the function not supported by the general-purpose scan software 202 and display the detailed settings screen 300C shown in FIG. 3C.

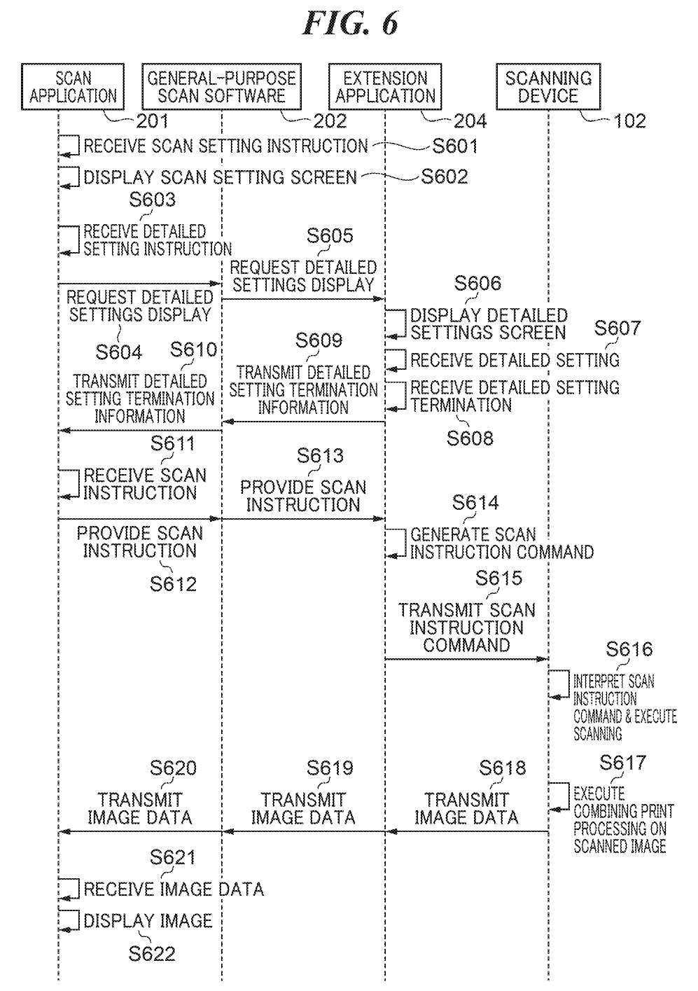

FIG. 6 is a sequence diagram showing a process executed between the scan application 201, the general-purpose scan software 202, the extension application 204, and the scanning device 102, after the scan application 201 receives a scan setting instruction. Processing operations performed by the scan application 201, the general-purpose scan software 202, and the extension application 204 are executed by the CPU 111 of the host computer 101. This processing program is stored in the external storage device 114. Then, the CPU 111 loads the processing program from the external storage device 114 into the RAM 113 and executes the loaded processing program. Further, processing operations performed by the scanning device 102 are executed by the CPU 191 of the scanning device 102. This processing program is stored in the external storage device 199. The CPU 191 loads the processing program from the external storage device 199 into the RAM 193 and executes the loaded processing program. Note that the processing operations in the scanning device 102 can be executed by the CPU 111 via the CPU 191. Further, the software configuration of the scan system 1000 is the software configuration shown in FIG. 2B.

Referring to FIG. 6, in a step S601, the scan application 201 receives a scan setting instruction by a user. The user can instruct the scan setting to the scan application 201 by operating e.g. the pointing device 117 and/or the keyboard 118.

In a step S602, the scan application 201 displays the scan setting screen 300A shown in FIG. 3A on the display section 119.

In a step S603, the scan application 201 receives a detailed setting instruction provided by the user. The user can instruct the detailed setting by operating e.g. the pointing device 117 and/or the keyboard 118 to select the control 302 on the scan setting screen 300A.

In a step S604, the scan application 201 requests the general-purpose scan software 202 to display the detailed settings.

In a step S605, the general-purpose scan software 202 requests the extension application 204 to display the detailed settings.

In a step S606, the scan setting screen-extending unit 205 of the extension application 204 displays the detailed settings screen 300C shown in FIG. 3C on the display section 119 in response to the request received in the step S605 (display control step). As described hereinabove, the combining instruction setting is added to the scan function information 203 by the scan function-extending unit 206. The scan setting screen-extending unit 205 can display the detailed settings screen 300C by referring to the capabilities information generated based on the scan function information 203 to which this combining instruction setting has been added. Note that in the present embodiment, the file format supported by the extension application 204 is one type, i.e. JPEG. Therefore, the file format can be omitted from the detailed settings screen 300C, i.e. the display of the file format can be inhibited. Note that the file format can be displayed in a grayed-out state in the detailed settings screen 300C.

In a step S607, the scan setting screen-extending unit 205 receives a detailed setting input by the user on the detailed settings screen 300C. Note that, here, on the detailed settings screen 300C, the scanning location “the original platen glass” is selected by the control 305, by way of example. Further, “date/time” is selected by the control 307, “YYYY/MM/DD” is selected by the control 309, and “upper left” is selected by the control 311 (see FIG. 3C). In this selection state, the scan setting screen-extending unit 205 receives an operation of the control 306, performed by the user on the detailed settings screen 300C. With this, the CPU 111 stores the selection state on the detailed settings screen 300C in the RAM 113.

In a step S608, the scan setting screen-extending unit 205 receives termination of the detailed setting performed by the user based on the operation of the control 306 in the step S607. Note that the user can instruct termination of the detailed setting by operating e.g. the pointing device 117 and/or the keyboard 118 to select the control 306. With this, the setting state on the detailed settings screen 300C is written into the scan function information 203. Note that the information written into the scan function information 203 can also include, for example, the information inhibited from being displayed or displayed in the grayed-out state.

In a step S609, the extension application 204 transmits detailed setting termination information to the effect that the detailed setting in the S608 has been terminated, to the general-purpose scan software 202.

In a step S610, the general-purpose scan software 202 receives the detailed setting termination information sent from the extension application 204 in the step S609. Then, the general-purpose scan software 202 transmits this detailed setting termination information to the scan application 201.

In a step S611, the scan application 201 receives a scan instruction provided by the user. The user can provide the scan instruction, i.e. the instruction for reading an original, by operating e.g. the pointing device 117 and/or the keyboard 118 to select the control 303 on the scan setting screen 300A (see FIG. 3A).

In a step S612, the scan application 201 provides the scan instruction received in the step S611 to the general-purpose scan software 202.

In a step S613, the general-purpose scan software 202 receives the scan instruction provided in the step S612. Then, the general-purpose scan software 202 provides this scan instruction to the extension application 204.

In a step S614, the extension application 204 receives the scan instruction given in the step S613. Then, the extension application 204 generates a scan instruction command based on the scan function information 203 in which the setting state on the detailed settings screen 300C has been written in the step S608. Note that this scan instruction command includes the combining instruction setting information concerning the combining instruction setting received on the detailed settings screen 300C. Further, there is a case where the information inhibited from being displayed or displayed in the grayed-out state in the step S608 has not been written into the scan function information 203. In this case, in the step S614, the extension application 204 can add the information which has not been written into the scan function information 203 to the scan instruction command or set the same as the default value.

In a step 615, the extension application 204 transmits the scan instruction command generated in the step S614 to the scanning device 102. With this, an execution instruction set on the scan setting screen 300A is given to the scanning device 102 (instruction step).

In a step S616, the input/output interface 198 of the scanning device 102 receives the scan instruction command transmitted in the step S615. Then, the reading section 195 of the scanning device 102 interprets the scan instruction command and executes scanning under the conditions set on the detailed settings screen 300C. As a result, image data (read image data) of the original is obtained.

In a step S617, the scanning device 102 executes combining print processing for combining a combining print item with the image data obtained in the step S616 based on the combining instruction setting information included in the scan instruction command.

In a step S618, the input/output interface 198 of the scanning device 102 transmits the image data obtained by the combining print processing in the step S617 to the extension application 204.

In a step 619, the extension application 204 receives the image data transmitted in the step S618. Then, the extension application 204 transmits this image data to the general-purpose scan software 202. Note that in a case where there are a plurality of image data items, the extension application 204 can collectively transmit the image data to the general-purpose scan software 202 after receiving all of the image data items or transmit the image data to the general-purpose scan software 202 whenever each image data is received.

In a step S620, the general-purpose scan software 202 receives the image data sent in the step S619. Then, the general-purpose scan software 202 transmits this image data to the scan application 201.

In a step S621, the scan application 201 receives the image data sent in the step S620.

In a step S622, the scan application 201 displays the image data received in the step S621 on the display section 119. As a result, the image data on which the combining print has been combined is displayed on the display section 119 as a preview image.

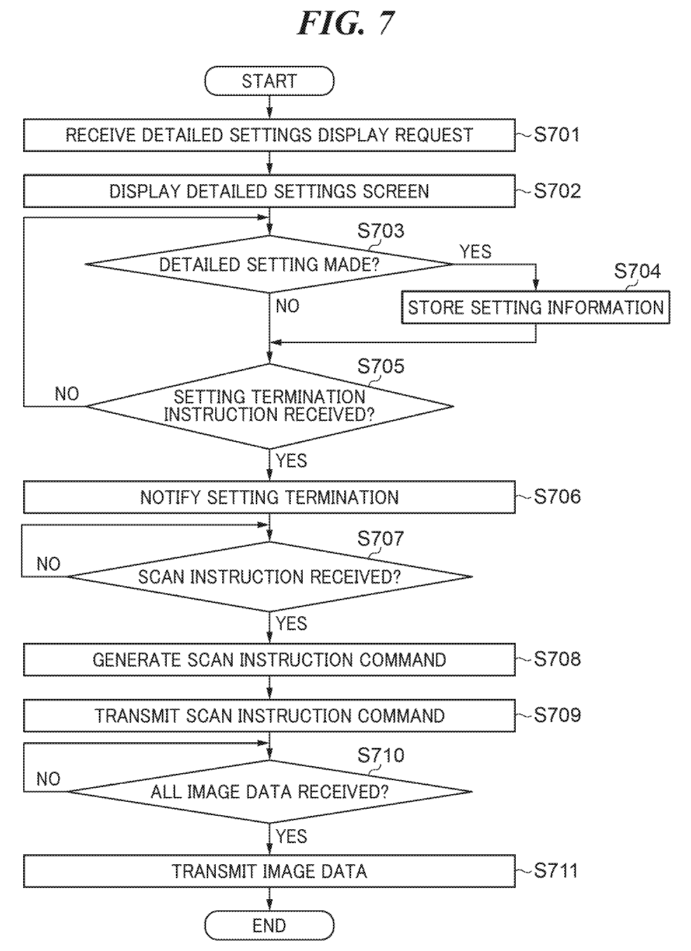

FIG. 7 is a flowchart of the process performed by the extension application 204. A program for executing the process in FIG. 7 is stored in the external storage device 114. The CPU 111 can execute the present process by loading the program from the external storage device 114 into the RAM 113. Referring to FIG. 7, in a step S701, the extension application 204 receives a request for displaying the detailed setting (see the step S605) from the general-purpose scan software 202.

In a step S702, similar to the step S606, the scan setting screen-extending unit 205 of the extension application 204 displays the detailed settings screen 300C shown in FIG. 3C on the display section 119 in response to the detailed settings display request received in the step S701. As described hereinabove, the combining instruction setting is added to the scan function information 203. The scan setting screen-extending unit 205 can display the detailed settings screen 300C by referring to the capabilities information generated based on this scan function information 203.

In a step S703, the scan setting screen-extending unit 205 determines whether or not settings have been made on the controls on the detailed settings screen 300C. If it is determined in the step S703 that settings have been made on the controls, the process proceeds to a step S704. On the other hand, if it is determined in the step S703 that settings have not been made on the controls, the process proceeds to a step S705.

In the step S704, similar to the step S607, the scan setting screen-extending unit 205 stores (saves) the setting states (setting information) on the controls on the detailed settings screen 300C in the RAM 113. After execution of the step S704, the process proceeds to the step S705.

In the step S705, the scan setting screen-extending unit 205 determines whether or not a detailed setting termination instruction has been provided on the detailed settings screen 300C, i.e. whether or not the control 306 has been operated. If it is determined in the step S705 that a detailed setting termination instruction has been provided (see the step S608), the process proceeds to a step S706. On the other hand, if it is determined in the step S705 that the detailed setting termination instruction has not been provided, the process returns to the step S703 to sequentially execute the step S703 et seq.

In the step S706, similar to the step S609, the extension application 204 notifies the general-purpose scan software 202 of the detailed setting termination instruction provided in the step S705.

In a step S707, the extension application 204 determines whether or not a scan instruction has been provided from the general-purpose scan software 202 (see the step S613). If it is determined in the step S707 that the scan instruction has been provided, the process proceeds to a step S708. On the other hand, if it is determined in the step S707 that the scan instruction has not been provided, the process remains in the step S707.

In the step S708, similar to the step S614, the extension application 204 generates a scan instruction command based on the scan function information 203 in which the setting state on the detailed settings screen 300C has been written. Further, as the method of generating a scan instruction command, for example, a method of extending a standard protocol command can be used. Further, as this extension method, for example, a method of describing a dedicated command in an extended area of the standard protocol command can be used. The other extension methods include a method of adding an original standard command to the end of the standard protocol command, a method of the extension application 204 overwriting the standard protocol command with an original command system, and so forth. Further, in a case where an instruction is provided from the extension application 204, instruction and communication can be performed according to a protocol unique to a maker regardless of the standard protocol.

In a step S709, similar to the step S615, the extension application 204 transmits the scan instruction command generated in the step S708 to the scanning device 102.

In a step S710, the extension application 204 determines whether or not all of the image data (see the step S617) from the scanning device 102 have been received. If it is determined in the step S710 that all of the image data have been received, the process proceeds to a step S711. On the other hand, if it is determined in the step S710 that all of the image data have not been received, the process remains in the step S710.

In the step S711, similar to the step S618, the extension application 204 transmits all the image data, which has been received from the scanning device 102 and determined in the step S710, to the general-purpose scan software 202.

As described above, in the scan system 1000, even in a case where the general-purpose scan software 202 does not support the combining instruction setting, it is possible to execute the combining instruction setting by using the extension application 204. With this, even in a case where the general-purpose scan software 202 is used, it is possible to give a combining instruction to the scanning device 102. Further, in the step S613, the scan instruction is provided from the general-purpose scan software 202 to the extension application 204, but this is not limitative. For example, the scan instruction can be provided from the scan application 201 to the extension application 204. Further, a control for a scan instruction can be disposed on the detailed settings screen 300C. In this case, when the user operates the control for a scan instruction, a scan instruction is provided to the extension application 204. Further, the image data can be transmitted from the scanning device 102 to the scan application 201 via the extension application 204 without via the general-purpose scan software 202. Further, the image data can be transmitted from the scanning device 102 directly to the scan application 201. Further, the scan system 1000 can be configured such that the image data is stored in the external storage device 114, and only information of a file path as the storage destination can be sent and received.

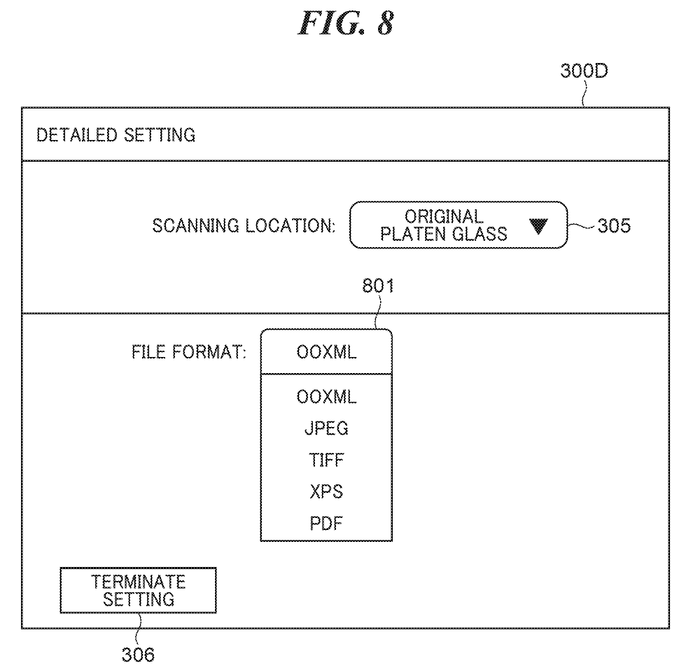

Next, a second embodiment will be described below with reference to FIGS. 8 to 11, but the description will be given mainly of different points from the above-described embodiment, and description of the same points is omitted. In the first embodiment, the scanning device 102 interprets the scan setting information including the combining print setting and performs the combining print processing after scanning. The file format set when the format is converted at this time is JPEG. Therefore, the scanning device 102 performs the combining print and JPEG image processing. Incidentally, depending on a type of the scanning device 102, it is possible to perform scanning with designation of a file format, but the file format is sometimes limited. In this case, even when the extension application 204 can generate the scan setting information including designation of a file format, it can be difficult to cause the scanning device 102 to execute processing for converting the format to the designated file format.

Further, there is a configuration that is capable of reducing this phenomenon. As the outline of this configuration, first, file formats to which the format can be changed are determined based on the capabilities information of the scanning device 102. Then, in a case where a file format designated by the user is a file format which can be converted by the scanning device 102, the scan setting information including the file format designated by the user is generated and transmitted to the scanning device 102. On the other hand, in a case where a file format designated by the user is not a file format which can be converted by the scanning device 102, the scan setting information is generated for image data before converting the format and is transmitted to the scanning device 102. After that, the extension application 204 converts the format of the image data read by the scanning device 102 to the designated file format. With this, even when the designated format is a file format difficult to be converted by the scanning device 102, it is possible to provide image data to the user in the desired file format. However, in this configuration, in a case where format conversion is performed on image data on which the combining print processing has been executed, the combining print item can be combined and printed in a position which is not intended by the user. To cope with this, in the present embodiment, a description will be given of a configuration that is capable of reducing the phenomenon that the combining print item is combined and printed in a position which is not intended by the user.

FIG. 8 is a diagram showing an example of a screen displayed on the display section of the scan system according to the second embodiment. A detailed settings screen 300D shown in FIG. 8 is an additional screen displayed on the display section 119 by the scan setting screen-extending unit 205 separately from the detailed settings screen 300C shown in FIG. 3C. The detailed settings screen 300D includes a control 801 as the combining instruction setting. On the control 801, file formats set when converting the format are displayed in a list. The file formats include OOXML, JPEG, TIFF, XPS, and PDF. Then, the user can select at least one of these as desired. The state shown in FIG. 8 is a state in which OOXML is selected. Thus, the control 801 functions as a file format selection section for selecting a file format. Then, by selecting a file format on the control 801, it is possible to switch scanning to scanning in the selected file format. Note that the file formats included in the control 801 are not limited to OOXML, JPEG, TIFF, XPS, and PDF, but, for example, PNG, DOC, PPT, XLS, TXT, CSV, and so forth can be used.

In the present embodiment, for example, it is assumed that the scanning device 102 is a device which does not support the file format OOXML. Further, the extension application 204 can execute the processing for converting the format of image data. In this case, if the designated file format is not included in the capabilities information acquired from the scanning device 102, the scan function-extending unit 206 adds the designated file format to the scan function information 203. The image data-editing unit 207 performs the processing for converting the image data format of the image data received from the scanning device 102 based on the file format of the combining print function, set by the user. Further, the image data-editing unit 207 executes the combining print processing on the file whose format has been converted.

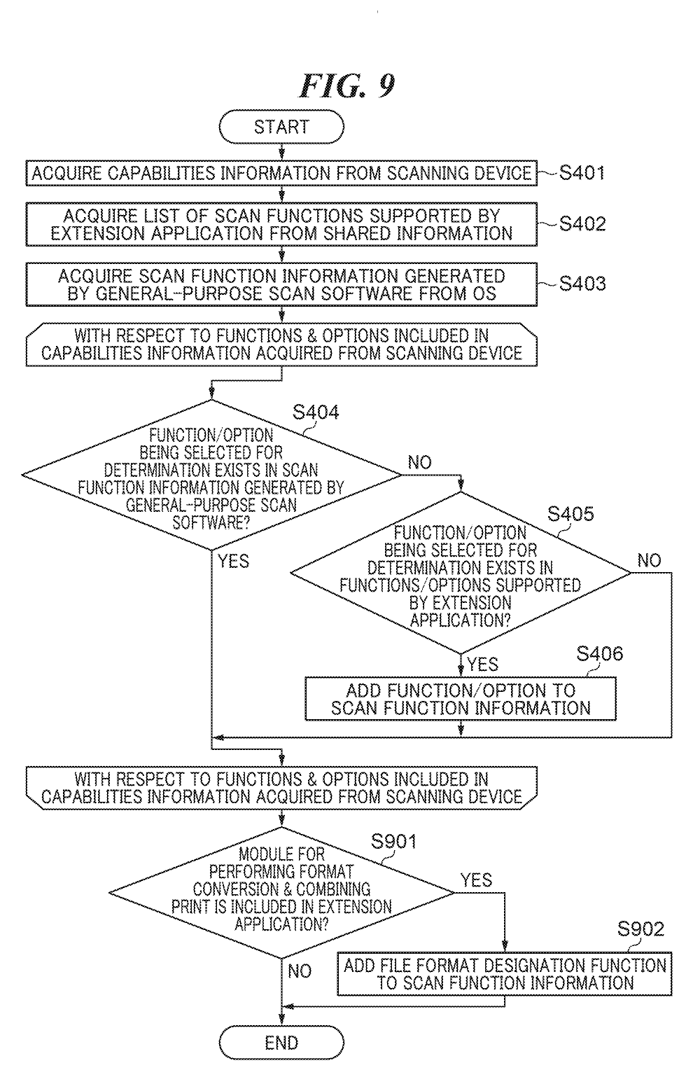

FIG. 9 is a flowchart of a process performed by the scan function-extending unit 206, for editing the scan function information. Note that a program for executing the process in FIG. 9 is executed by the scan function-extending unit 206 under the control of the CPU 111. Further, the process in FIG. 9 is formed by adding steps S901 and S902 to the process in FIG. 4. Referring to FIG. 9, in a case where the processing operations for repeating the steps S404 to S406 are terminated, the process proceeds to the step S901. As mentioned above, the scanning device 102 does not support the file format OOXML. Therefore, in the scan function information 203 after the processing operations from the steps S404 to S406 are terminated, the file format OOXML has not been added.

As shown in FIG. 9, in the step S901, the scan function-extending unit 206 determines whether or not a module that is capable of executing the format conversion processing and the combining print processing exists in the extension application 204. This determination is performed by referring to the capabilities information of the scanning device 102 and the scan function information 203. If it is determined in the step S901 that the corresponding module exists, the process proceeds to the step S902. On the other hand, if it is determined in the step S901 that the corresponding module does not exist, the process is terminated. In the present embodiment, in the extension application 204, the image data-editing unit 207 can execute the format conversion processing. Therefore, it is determined in the step S901 that the corresponding module exists, and hence the process proceeds to the step S902.

In the step S902, the scan function-extending unit 206 adds a file format designation function, followed by terminating the process.

As described above, the extension application 204 can add, to the scan function information 203, a function which is not supported by the general-purpose scan software 202 but can be supported by the scanning device 102, and at the same time can be supported by the extension application 204. Then, the extension application 204 determines whether or not the format conversion processing can be executed. As a result of this determination, if it is determined that the format conversion processing can be executed, the file format designation function is added to the scan function information 203. By this addition processing, even when a specific image format conversion function is not supported by the scanning device 102, the scan setting screen-extending unit 205 can display the detailed settings screen 300D shown in FIG. 8.

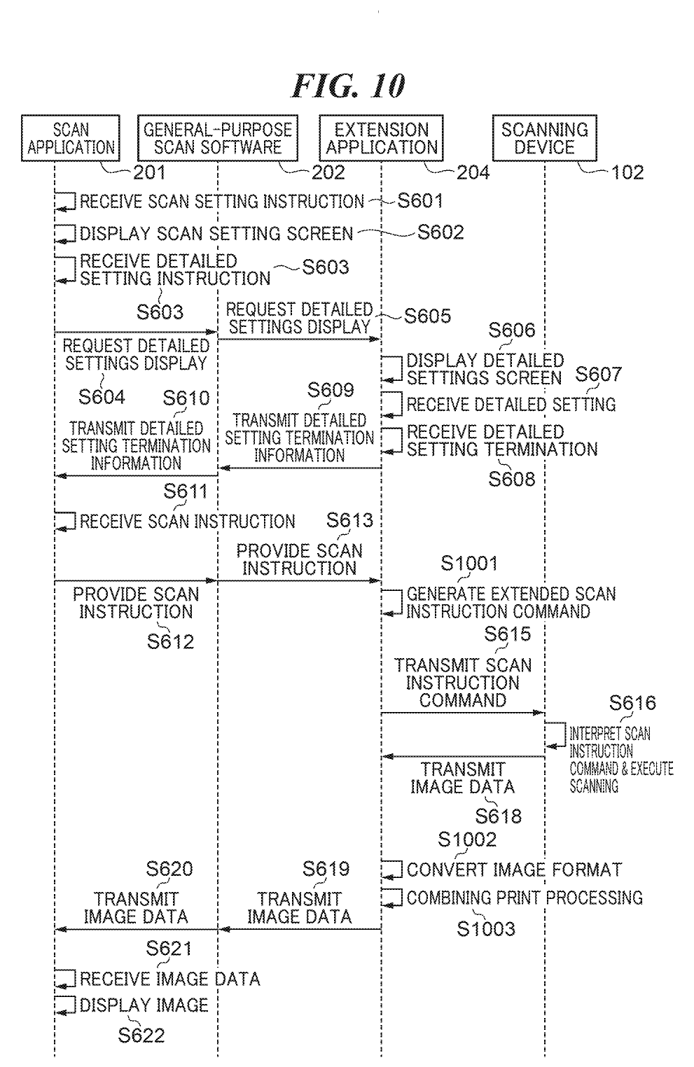

FIG. 10 is a sequence diagram showing a process executed between the scan application 201, the general-purpose scan software 202, the extension application 204, and the scanning device 102, after the scan application 201 receives a scan setting instruction. In the sequence diagram shown in FIG. 10, differently from the sequence diagram shown in FIG. 6, a step S1001 is executed in place of the step S614. Further, the step S617 is omitted. Further, a step S1002 and a step S1003 are executed between the steps S618 and S619. Referring to FIG. 10, in the step S1001, the extension application 204 generates an extended scan instruction command based on the scan function information 203 in which the setting state on the detailed settings screen 300C has been written in the step S608. Note that the scan function information 203 is in a state in which the file format designation function has been added as described above.

In the step S1002, the image data-editing unit 207 of the extension application 204 performs format conversion on the image data transmitted in the step S618. With this, the image data is converted to the designated file format.

In the step S1003, the image data-editing unit 207 executes the combining print processing for combining a combining print item with the image data whose format has been converted in the step S1002.

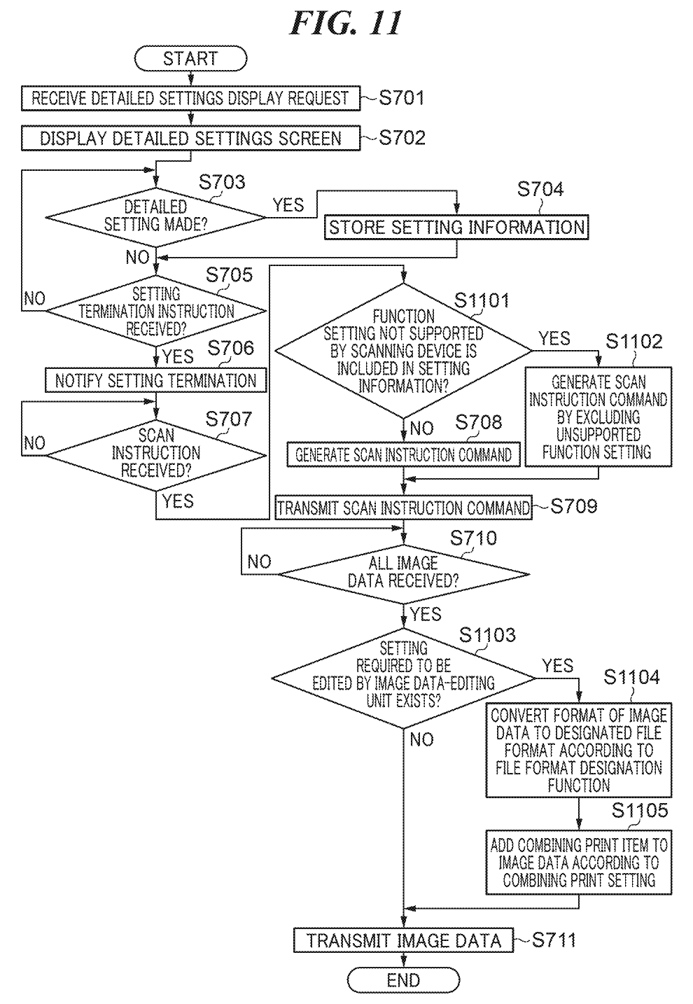

FIG. 11 is a flowchart of a process performed by the extension application. In the process in FIG. 11, differently from the process in FIG. 7, a step S1101 is executed between the steps S707 and S708. Further, a step S1103 is executed between the steps S710 and S711. Referring to FIG. 11, in the step S1101, the extension application 204 acquires the capabilities information of the scanning device 102 from the shared information 208. Note that in a case where the capabilities information of the scanning device 102 has not been stored in the shared information 208, the scan function-extending unit 206 can request the capabilities information of the scanning device 102 to the scanning device 102 and store the capabilities information in the shared information 208. With this, it is possible to acquire the capabilities information of the scanning device 102 from the shared information 208. Then, the extension application 204 determines, based on this capabilities information and the detailed setting information, whether or not the detailed setting information includes a function setting which is not supported by the scanning device 102. As a result of this determination, if it is determined that the detailed setting information includes a function setting which is not supported by the scanning device 102, the process proceeds to a step S1102. On the other hand, if it is determined that the detailed setting information includes no function which is not supported by the scanning device 102, the process proceeds to the step S708. In the present embodiment, the combining instruction and the format conversion, which are not supported by the scanning device 102, are set. Therefore, it is determined in the step S1101 that the detailed setting information includes a function setting which is not supported by the scanning device 10.

In the step S1102, the extension application 204 generates a scan instruction command by excluding the function setting which is not supported by the scanning device 102. In the present embodiment, the combining instruction-setting function is not included in the scan instruction command. After execution of the step S1102, the process proceeds to the step S709.

In the step S1103, the extension application 204 determines based on the detailed setting information whether or not there is a setting required to be edited by the image data-editing unit 207. If it is determined in the step S1103 that there is a setting required to be edited, the process proceeds to a step S1104. On the other hand, if it is determined in the step S1103 that there is no setting required to be edited, the process proceeds to the step S711. In the present embodiment, the format conversion which is not supported by the scanning device 102 has been set, and hence it is determined in the step S1103 that there is a setting required to be edited.

In the step S1104, the image data-editing unit 207 of the extension application 204 converts the acquired image data to the designated file format, based on the file format setting determined in the step S703.

In a step S1105, the image data-editing unit 207 adds the combining print item to the image data according to the combining print setting. After execution of the step S1105, the process proceeds to the step S711.

As described above, in the present embodiment, in the step S1101, for example, whether or not the processing for converting image data to the file format OOXML selected on the control 801 can be performed by the scanning device 102 is determined (determination step). Then, as a result of this determination, if it is determined that the file conversion processing cannot be performed by the scanning device 102, the steps S618, S1002, and S1003 in FIG. 10 are sequentially executed. In the step S618, the image data generated by executing the scan function in the step S616 is transmitted from the scanning device 102. With this, the extension application 204 can acquire the image data from the scanning device 102 (acquisition step). In the step S1002, the format of the image data acquired by the extension application 204 is converted (conversion step). In the step S1003, the combining print item is combined with the image data, whose format has been converted in the step S1002, based on the combining instruction set on the detailed settings screen 300C (combining step). On the other hand, if it is determined in the step S1101 that the file conversion processing and the like can be performed by the scanning device 102, the steps S1002 and S1003 in FIG. 10 are omitted, and the steps S615 to S622 are sequentially executed as described above. Thus, in the present embodiment, even in a case where e.g. the combining print function is not supported by the scanning device 102, it is possible to provide the combining print function to the user. With this, it is possible to reduce the phenomenon that the combining print item is printed in a position which is not intended by the user.

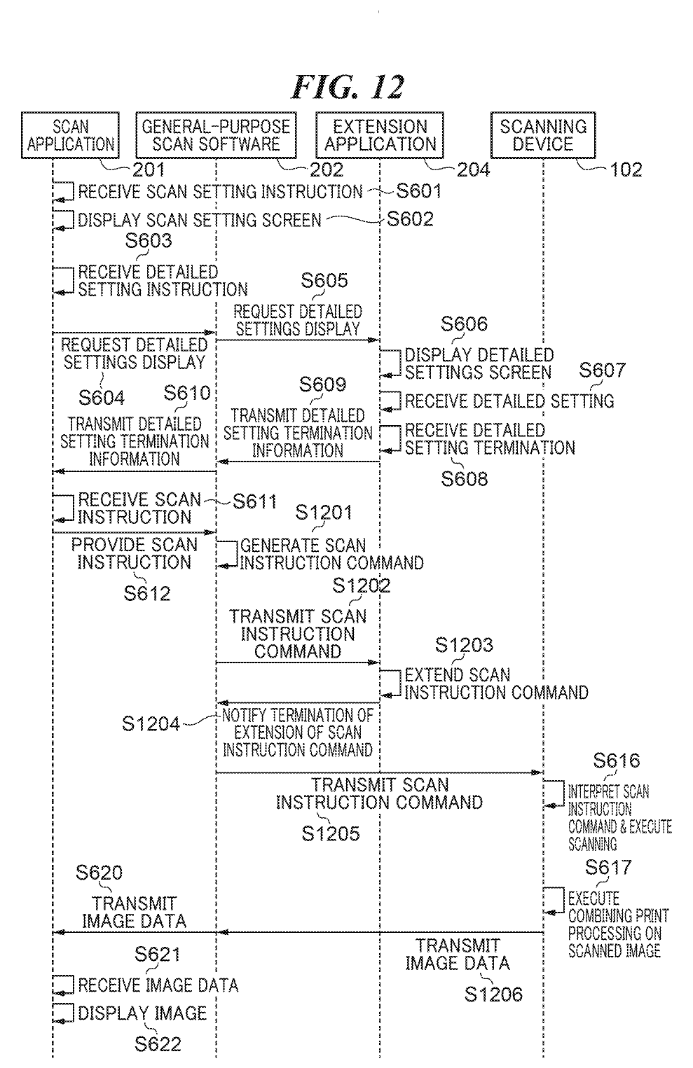

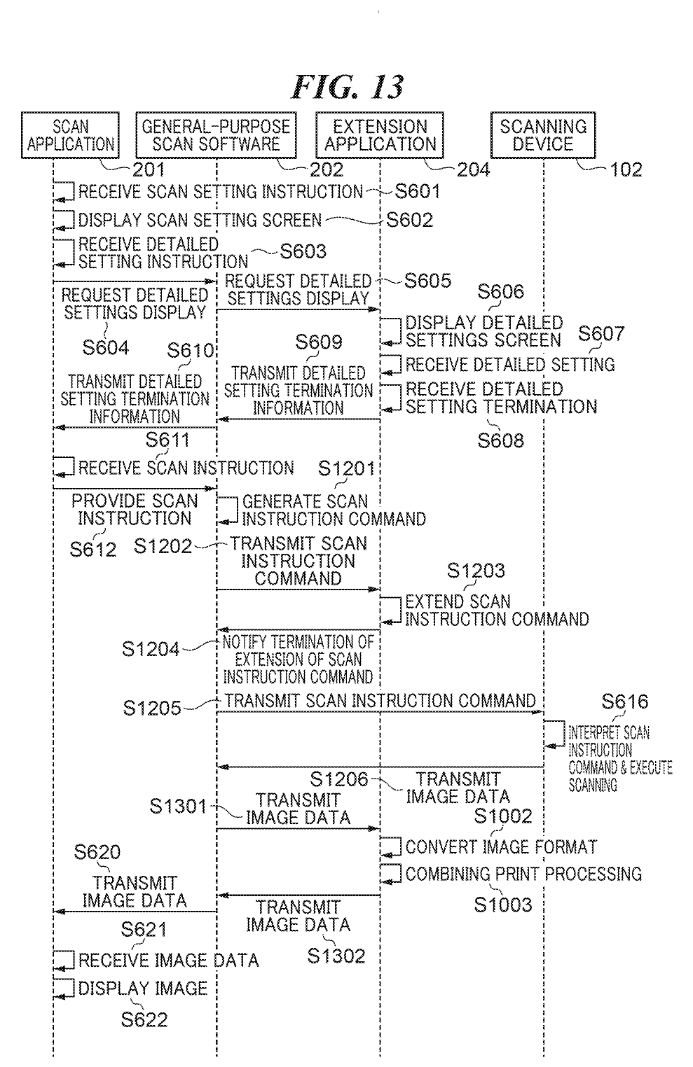

Next, a third embodiment will be described below with reference to FIGS. 12 and 13, but the description will be given mainly of different points from the above-described embodiments, and description of the same points is omitted. In the first embodiment, the information is transmitted and received between the extension application 204 and the scanning device 102. In the present embodiment, the information is transmitted and received between the general-purpose scan software 202 and the scanning device 102 in place of between the extension application 204 and the scanning device 102. Further, the extension application 204 extends a scan instruction command and edits an image. FIG. 12 is a sequence diagram showing a process executed, in the third embodiment, between the scan application 201, the general-purpose scan software 202, the extension application 204, and the scanning device 102, after the scan application 201 receives a scan setting instruction. In the sequence diagram shown in FIG. 12, differently from the sequence diagram shown in FIG. 6, steps S1201 to S1205 are sequentially executed in place of the steps S613 to S615. Further, a step S1206 is executed in place of the steps S618 and S619.

Referring to FIG. 12, in the step S1201, the general-purpose scan software 202 receives the scan instruction provided in the step S612. Then, the general-purpose scan software 202 generates a scan instruction command. This scan instruction command does not include a function which is not supported by the general-purpose scan software 202.

In the step S1202, the general-purpose scan software 202 transmits the scan instruction command generated in the step S1201 to the extension application 204.

In the step S1203, the extension application 204 receives the scan instruction command transmitted in the step S1202. Then, the extension application 204 adds an instruction command for a function which is not supported by the general-purpose scan software 202 or changes the existing instruction with respect to this scan instruction command. This extends the scan instruction command. In the present embodiment, the scan instruction command generated in the step S1201 does not include the combining instruction setting, and hence the combining instruction setting is added in the step S1203.

In the step S1204, the extension application 204 provides a notification to the effect that extension of the scan instruction command in the step S1203 is terminated and transmits the scan instruction command extended in the step S1203 to the general-purpose scan software 202.

In the step S1205, the general-purpose scan software 202 receives the extended scan instruction command transmitted in the step S1204. Then, the general-purpose scan software 202 transmits this extended scan instruction command to the scanning device 102. With this, the scan operation in the step S616 is executed.

In the step S1206, the input/output interface 198 of the scanning device 102 transmits the image data obtained in the step S617 to the general-purpose scan software 202. With this, the general-purpose scan software 202 can receive the image data from the scanning device 102. This image data is data on which the combining print processing has been executed.

FIG. 13 is a sequence diagram (variation) showing a process executed between the scan application 201, the general-purpose scan software 202, the extension application 204, and the scanning device 102, after the scan application 201 receives a scan setting instruction. In the sequence diagram shown in FIG. 13, differently from the sequence diagram shown in FIG. 12, the step S617 is omitted. Further, a step S1301, the step S1002, the step S1003, and a step S1302 are sequentially executed between the steps S1206 and S620. Referring to FIG. 13, in the step S1301, the general-purpose scan software 202 receives the image data transmitted in the step S1206. Then, the general-purpose scan software 202 transmits this image data to the extension application 204.

After execution of the step S1301, the process executes the above-described steps S1002 and S1003.

In the step S1302, the extension application 204 transmits the image data on which the combining print processing has been executed in the step S1003 to the general-purpose scan software 202.

As described above, the extension application 204 can extend the file format designation command. With this, it is possible to cause the scanning device 102 to realize the file format designation function.

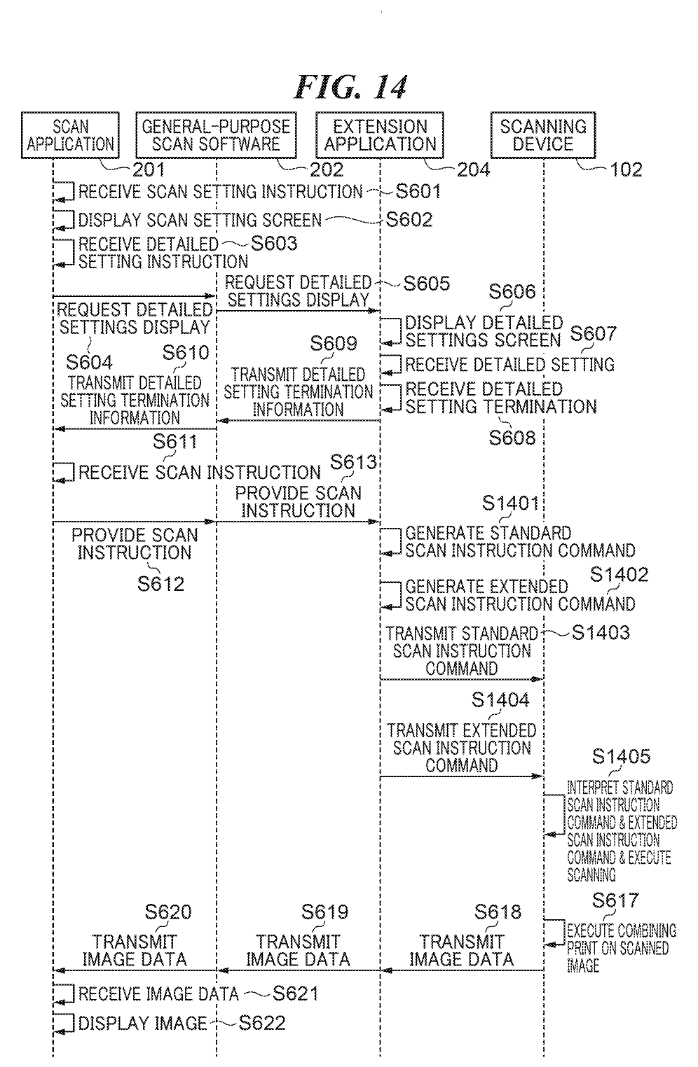

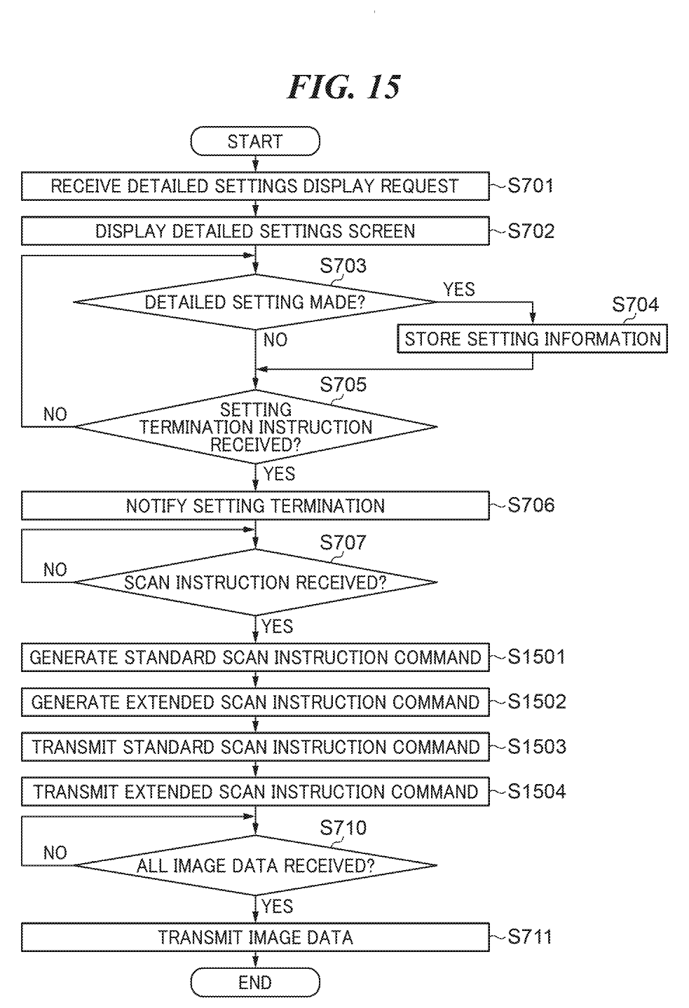

Next, a fourth embodiment will be described below with reference to FIGS. 14 and 15, but the description will be given mainly of different points from the above-described embodiments, and description of the same points is omitted. In the first embodiment, the command used according to the standard protocol is extended, and the information is transmitted and received to and from the scanning device 102. In the present embodiment, the command used according to the standard protocol is not extended. Further, for a function which is supported only by the extension application 204, the information is transmitted and received to and from the scanning device 102 using a separate command. FIG. 14 is a sequence diagram showing a process executed, in the fourth embodiment, between the scan application 201, the general-purpose scan software 202, the extension application 204, and the scanning device 102, after the scan application 201 receives a scan setting instruction. In the sequence diagram shown in FIG. 14, differently from the sequence diagram shown in FIG. 6, steps S1401 to S1405 are sequentially executed in place of the steps S614 to S616.

Referring to FIG. 14, in the step S1401, the extension application 204 receives the scan instruction provided in the step S613. Then, the extension application 204 generates a standard scan instruction command according to the standard protocol. Note that this standard scan instruction command does not include a function which is not supported by the standard protocol.

In the step S1402, the extension application 204 generates an extended scan instruction command for a function which is supported only by the extension application 204.

In the step S1403, the extension application 204 transmits the standard scan instruction command generated in the step S1401 to the scanning device 102.

In the step S1404, the extension application 204 transmits the extended scan instruction command generated in the step S1402 to the scanning device 102.

In the step S1405, the input/output interface 198 of the scanning device 102 receives the standard scan instruction command transmitted in the step S1403 and the extended scan instruction command transmitted in the step S1404. Then, the reading section 195 of the scanning device 102 interprets the standard scan instruction command and the extended scan instruction command, respectively, and executes scanning.

As described above, in the present embodiment, the combining instruction-setting function is not extended for the standard scan instruction command, and for the combining instruction-setting function supported only by the extension application 204, the separate scan instruction command can cope with this. With this, it is possible to perform scanning under the combining instruction setting. Note that the execution order of the steps S1401 to S1404 can be changed to the order of the steps S1401, S1403, S1402, and S1404.

FIG. 15 is a flowchart of a process performed by the extension application 204. In the process in FIG. 15, differently from the process in FIG. 7, steps S1501 to S1504 are sequentially executed in place of the steps S708 and S709. Referring to FIG. 15, in the step S1501, the extension application 204 generates a standard scan instruction command according to the standard protocol. This step S1501 corresponds to the step S1401 in FIG. 14.

In the step S1502, the extension application 204 generates an extended scan instruction command for the function which is not supported by the standard protocol but is supported only by the extension application 204. This step S1502 corresponds to the step S1402 in FIG. 14.

In the step S1503, the extension application 204 transmits the standard scan instruction command generated in the step S1501 to the scanning device 102. This step S1503 corresponds to the step S1403 in FIG. 14.

In the step S1504, the extension application 204 transmits the extended scan instruction command generated in the step S1502 to the scanning device 102. This step S1504 corresponds to the step S1404 in FIG. 14. After execution of the step S1504, the process proceeds to the step S710.

As described above, in the present embodiment, for the function which is not supported by the standard protocol, the separate scan instruction command can be transmitted from the extension application 204. With this, it is possible to provide the combining print function to the user.

According to the present disclosure, even in a case where the standard driver is used, it is possible to give a combining instruction for combining additional data with image data generated by executing the reading function.

### Other Embodiment

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-036274, filed Mar. 7, 2025, which is hereby incorporated by reference herein in its entirety.

What is claimed is:

1. A non-transitory computer-readable storage medium storing an application program supporting a standard driver which is provided from a provider of an operating system, the application program causing an information processing apparatus to execute a control method comprising:
displaying a reception screen for receiving a setting of a combining instruction for combining additional data with image data generated by executing a reading function of an image processing apparatus for reading an original; and
transmitting the combining instruction set on the reception screen to the image processing apparatus.

2. The non-transitory computer-readable storage medium according to claim 1, wherein on the reception screen, as the additional data, at least one of a date/time at which the reading function is executed, a date/time at which the image data is transmitted from the image processing apparatus, a page number set when the image data is visualized, a header set when the image data is visualized, and a footer set when the image data is visualized can be selected.

3. The non-transitory computer-readable storage medium according to claim 2, wherein the reception screen includes a changing section for changing a display form used when a date on which the reading function is executed or a date on which the image data is transmitted from the image processing apparatus is visualized, as a setting of the combining instruction.

4. The non-transitory computer-readable storage medium according to claim 2, wherein the reception screen includes a page selection section for selecting a target page to which the page number is to be added when the page number is visualized, as a setting of the combining instruction.

5. The non-transitory computer-readable storage medium according to claim 2, wherein the reception screen includes a position selection section for selecting a position at which the additional data is arranged when the additional data is visualized, as a setting of the combining instruction.

6. The non-transitory computer-readable storage medium according to claim 1, wherein on the reception screen, the setting of the combining instruction can be canceled.

7. The non-transitory computer-readable storage medium according to claim 1, wherein a function of setting the combining instruction is a function which cannot be executed by the standard driver.

8. A control method of performing control to support a standard driver which is provided from a provider of an operating system, comprising:
displaying a reception screen for receiving a setting of a combining instruction for combining additional data with image data generated by executing a reading function of an image processing apparatus for reading an original; and
transmitting the combining instruction set on the reception screen to the image processing apparatus.

9. An information processing apparatus including a standard driver which is provided from a provider of an operating system and an application program supporting the standard driver, the application program causing the information processing apparatus to execute a control method comprising:
displaying a reception screen for receiving a setting of a combining instruction for combining additional data with image data generated by executing a reading function of an image processing apparatus for reading an original; and
transmitting the combining instruction set on the reception screen to the image processing apparatus.
